(19) United States
(12) Patent Application Publication
(10) Pub. No.: US 2016/0304124 A1
(43) Pub. Date: Oct. 20, 2016

(54) VEHICLE CONTROL SYSTEM

(71) Applicant: TOYOTA JIDOSHA KABUSHIKI KAISHA, Toyota-shi (JP)

(72) Inventors: Tadashi FUJIYOSHI, Susono-shi (JP); Kazumi HOSHIYA, Gotemba-shi (JP); Yoshio ITO, Susono-shi (JP); Norimi ASAHARA, Numazu-shi (JP); Seiji KUWAHARA, Susono-shi (JP); Takahito ENDO, Nagaizumi-cho (JP); Kazuya ARAKAWA, Fujinomiya-shi (JP)

(73) Assignee: TOYOTA JIDOSHA KABUSHIKI KAISHA, Toyota-shi (JP)

(21) Appl. No.: 15/092,704

(22) Filed: Apr. 7, 2016

(30) Foreign Application Priority Data
Apr. 17, 2015 (JP) 2015-085139

(51) Int. Cl. B62D 15/02; G05D 1/00

(52) U.S. Cl. CPC B62D 15/025; G05D 1/0088

(57) ABSTRACT

A vehicle control system is provided to propel a vehicle in a stabilized manner when switching an operating mode from an autonomous mode to a manual mode. The vehicle control system is configured to: control an operating condition of the vehicle; determine an execution of steering operation by the driver; and continue the autonomous control of the steering wheel if the steering wheel cannot be operated by the driver when the autonomous control of the vehicle is interrupted by a manual operation of a driver and hence the operating mode is switched from the autonomous mode to the manual mode.

### CROSS REFERENCE TO RELATED APPLICATIONS

The present invention claims the benefit of priority to Japanese Patent Application No. 2015-085139 filed on Apr. 17, 2015 with the Japanese Patent Office, the entire contents of which are incorporated herein by reference in its entirety.

### BACKGROUND

1. Field of the Invention

Embodiments of the present invention relates to the art of a vehicle control system configured to switch an operating mode of a vehicle between manual mode and autonomous mode.

2. Discussion of the Related Art

U.S. Pat. No. 8,260,482 describes an autonomous driving system for vehicles. According to the teachings of U.S. Pat. No. 8,260,482, an operating mode of the automated vehicle is switched from an autonomous mode to a manual mode when control of the vehicle is relinquished by applying different degrees of pressure, for example, on a steering wheel of the vehicle. In this case, the control computer conveys status information to a passenger by illuminating elements of the vehicle to instruct the passenger to grip a steering wheel.

JP-A-2010-264829 describes a driving assist device includes a first control portion that controls a vehicle to carry out automated driving, and a second control portion that controls the vehicle to make a shift to manual driving, in which the vehicle travels on a basis of an driving operation by a driver. According to the teachings of JP-A-2010-264829, when the automated driving is cancelled, a manner of canceling the automated driving is changed in accordance with an elapsed time from a start of the automated driving.

Thus, according to the teachings of U.S. Pat. No. 8,260,482, the passenger is alerted if the control of the vehicle is relinquished during propulsion under the autonomous mode without gripping the steering wheel. In this situation, however, the operating mode of the vehicle is switched from the autonomous mode to the manual mode and hence a vehicle behavior may be disturbed during and switching of the operating mode. For example, the steering wheel may not be operated properly to avoid obstacle during and immediately after switching of the operating mode to the manual mode. In addition, if the autonomous control of the steering wheel is cancelled after switching to the manual mode under a condition that the steering wheel is not gripped by the driver, the steering wheel may not be operated properly to turn the vehicle as desired.

### SUMMARY

Aspects of the present application have been conceived noting the foregoing technical problems, and it is therefore an object of the present application is to provide a vehicle control system configured to stabilize vehicle behavior when switching the operating mode from the autonomous mode to the manual mode even if the steering wheel cannot be operated by the driver.

The present invention relates to a vehicle control system that is configured to select an operating mode of a vehicle from an autonomous mode in which the vehicle is operated autonomously and a manual mode in which the vehicle is operated manually by a driver, and to switch the operating mode from the autonomous mode to the manual mode when an autonomous control of the vehicle is interrupted by a manual operation of a driver. In order to achieve the above-explained objective, according to the preferred embodiment, the vehicle control system is provided with a controller that is configured to: control an operating condition of the vehicle; determine an execution of steering operation by the driver; and continue the autonomous control of the steering wheel if the steering wheel cannot be operated by the driver when the autonomous control of the vehicle is interrupted by a manual operation of a driver and hence the operating mode is switched from the autonomous mode to the manual mode.

In a non-limiting embodiment, the controller may be further configured to continue the autonomous control of the steering wheel if the steering wheel cannot be operated by the driver when the autonomous control of the vehicle is interrupted by a manual operation of a driver while the vehicle is making a turn and hence the operating mode is switched from the autonomous mode to the manual mode.

Thus, the vehicle control system according to the preferred embodiment switches the operating mode from the autonomous mode to a partial manual mode in which the steering wheel is continuously operated autonomously if the autonomous control of the vehicle is interrupted by a manual operation of an accelerator pedal or a brake pedal executed by the driver. According to the preferred embodiment, therefore, the steering wheel can be maneuvered autonomously even if the steering wheel has to be operated during or after switching the operating mode from the autonomous mode to the manual mode. For this reason, the vehicle behavior can be stabilized to continuously propel the vehicle in a stable manner.

Likewise, according to the preferred embodiment, the operating mode may also be switched to the above-mentioned partial manual mode even if the autonomous control of the vehicle is interrupted by the manual operation while the vehicle is making a turn. According to the preferred embodiment, therefore, the steering wheel can be maneuvered autonomously to make a turn as desired during or after switching the operating mode from the autonomous mode to the manual mode. For this reason, the vehicle behavior can be stabilized to continuously propel the vehicle in a stable manner.

### BRIEF DESCRIPTION OF THE DRAWINGS

Features, aspects, and advantages of exemplary embodiments of the present invention will become better understood with reference to the following description and accompanying drawings, which should not limit the invention in any way.

FIG. 1 is a schematic illustration showing the control system of the vehicle to which the control system according to the preferred embodiment is applied;

FIG. 2 is a flowchart showing a control example carried out by the control system; and

FIG. 3 is a flowchart showing another control example of the control carried out by the control system.

### DETAILED DESCRIPTION OF THE PREFERRED EMBODIMENT(S)

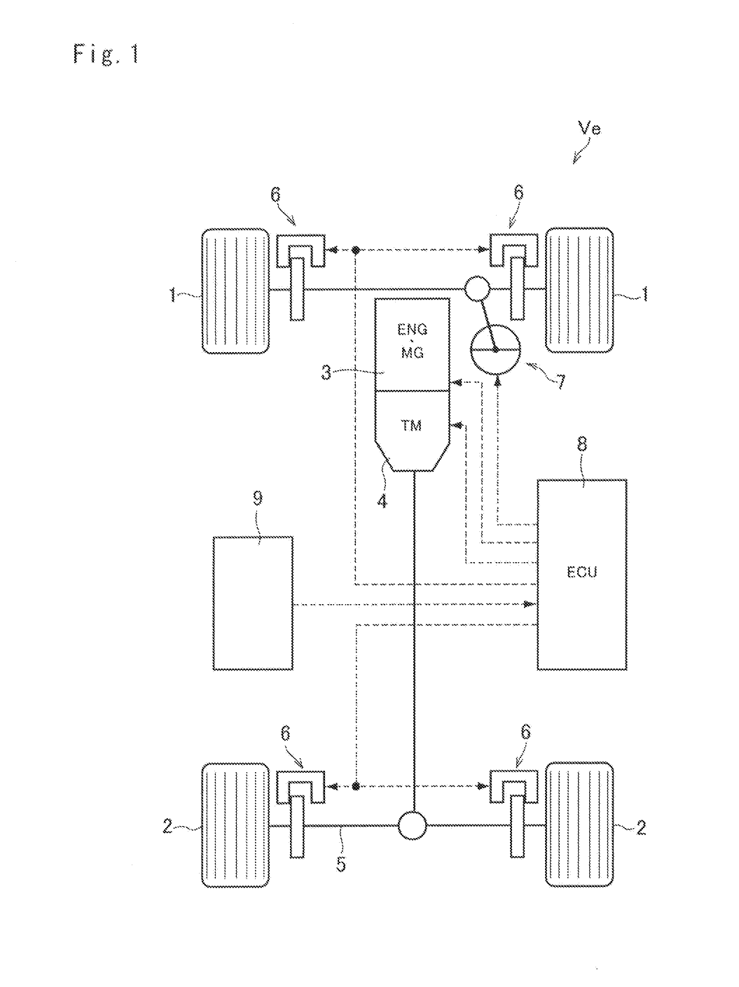

Preferred embodiments of the present application will now be explained with reference to the accompanying drawings. Referring now to FIG. 1, there is shown an example of a vehicle Ve to which the control system according to the preferred embodiment is applied. An operating mode of the vehicle Ve may be shifted between manual mode in which the vehicle Ve is operated manually by a driver and autonomous mode in which the vehicle Ve is operated autonomously. In the autonomous mode, the vehicle Ve is operated autonomously in line with a below-explained travel plan.

The vehicle Ve shown in FIG. 1 is a rear-wheel-drive vehicle comprising a pair of front wheels 1 and a pair of rear wheels 2. In the vehicle Ve, power of a prime mover 3 such as an engine and a motor-generator (referred to as “ENG” and “MG” in FIG. 1) is delivered to the rear wheels 2 through a transmission (referred to as “TM” in FIG. 1) 4 and a driveshaft 5 to propel the vehicle Ve, and a steering device 7 is connected to the front wheels 1. Here, it is to be noted that the control system may also be applied to a front-wheel-drive vehicle in which power of the prime mover 3 is delivered to the front wheels 1, and to a four-wheel-drive vehicle in which power of the prime mover 3 is delivered to both front wheels 1 and rear wheels 2.

For example, if an engine is used as the prime mover 3 to propel the vehicle Ve, the engine is started and stopped electrically, and output power thereof is also adjusted electrically. Specifically, given that a gasoline engine is used as the prime mover 3, an opening degree of a throttle valve, an amount of fuel supply, a commencement and a termination of ignition, an ignition timing etc. are controlled electrically. A permanent magnet type synchronous motor having a generating function, that is, a motor-generator may also be used as the prime mover 3. In this case, the prime mover 3 is connected with a battery (not shown) through an inverter (not shown) to control a rotational speed and a torque thereof so that the prime mover 3 can be operated selectively as a motor and a generator responsive to a current applied thereto.

As to the transmission 4, for example, a conventional geared automatic transmission, a belt-driven continuously variable transmission, a toroidal continuously variable transmission etc. may be used as the transmission 4. Given that the vehicle Ve is a hybrid vehicle, the transmission 4 includes a power distribution device for distributing and synthesizing powers of the engine and the motor(s).

Each brake device 6 is actuated by a brake actuator (not shown) to apply a braking force to the front wheels 1 and the rear wheels 2. That is, the braking force applied to the front wheels 1 or the rear wheels 2 is controlled by controlling actuation of the brake actuator.

The steering device 7 is adapted to turn the front wheels 1 of the vehicle Ve, and according to the preferred embodiment, the steering device 7 is provided with an electric power steering mechanism for assisting a steering power by an electric assist motor. Specifically, a steering angle of the front wheels 1 is controlled by actuating a steering actuator by the assist motor of the power steering mechanism.

In order to integrally control the prime mover 3, the transmission 4, the brake device 6 and the steering device 7, the vehicle Ve is further provided with a controller (referred to as “ECU” in FIG. 1) 8 as an electronic control unit composed mainly of a microcomputer. Specifically, detection signals and information from sensors 9 including on-board units are sent to the controller 8. Although only one controller is depicted in FIG. 1, a plurality of controllers 8 may be arranged in the vehicle Ve to control the above-listed devices individually.

Specifically, the sensor 10 includes an accelerator sensor for detecting an opening degree of an accelerator, a brake sensor (or switch) for detecting a depression of a brake pedal, a steering sensor for detecting a steering angle of the steering device 7, an engine speed sensor for detecting a speed of the engine, an output speed sensor for detecting a speed of an output shaft of the transmission 4, a vehicle speed sensor for detecting rotational speeds of the front wheels 1 and the rear wheels 2, a longitudinal acceleration sensor for detecting a longitudinal acceleration of the vehicle Ve, a lateral acceleration sensor for detecting a lateral acceleration of the vehicle Ve, a yaw rate sensor for detecting a yaw rate of the vehicle Ve, a steering touch sensor, a steering force sensor and so on.

The steering touch sensor is adapted to detect a fact that the driver grips the steering wheel. Specifically, the steering touch sensor transmits an OFF-signal if nobody touches the steering wheel, and an ON-signal if the driver grips the steering wheels with a predetermined pressure. The steering force sensor is adapted to detect a steering torque applied to the steering device 7.

In addition, the sensor 10 further includes at least one of the following external sensors for detecting an external condition, such as an on-board camera, a RADAR (i.e., a radio detection and ranging) a LIDAR (i.e., a laser imaging detection and ranging).

Specifically, the on-board camera is arranged inside of a windshield glass, and transmits recorded information about the external condition to the controller 8. To this end, not only a monocular camera but also a stereo camera having a plurality of lenses and image sensors to achieve a binocular vision may be used as the on-board camera. If the stereo camera is used as the on-board camera, the controller 9 is allowed to obtain three-dimensional information in the forward direction.

The RADAR is adapted to detect obstacles utilizing radio waves such as millimetric-waves and microwaves, and to transmit detected information to the controller 8. Specifically, the RADAR detects an obstacle such as other vehicle and so on by emitting radio waves and analyzing the radio waves reflected from the obstacle.

Likewise, the LIDAR is adapted to detect obstacles utilizing laser light and to transmit detected information to the controller 8. Specifically, the LIDAR detects an obstacle such as other vehicle and so on by emitting laser light and analyzing the laser light reflected from the obstacle.

In addition, the vehicle Ve is further provided with a GPS (i.e., global positioning system) receiver, a digital map database, and a navigation system. Specifically, the GPS receiver is adapted to obtain a position (i.e., latitude and longitude) based on incident signals from GPS satellites, and to transmit the positional information to the controller 8. The digital map database may be installed in the controller 8, but map information stored in external online information processing systems may also be available. The navigation system is configured to determine a travelling route of the vehicle Ve based on the positional information obtained by the GPS receiver and the map database.

The controller 8 carries out calculations based on the incident data or information from the sensor 10 and preinstalled data, and calculation results are sent in the form of command signal to the prime mover 3 and the transmission 4, and to the actuators of the brake device 6, the steering device 7 and so on.

In order to operate the vehicle Ve autonomously, the vehicle Ve is provided with a throttle actuator, a brake actuator, a steering actuator and so on. Specifically, the throttle actuator is adapted to change an opening degree of the throttle valve or an electric power supplied to the motor in response to reception of the command signal. The brake actuator is adapted to actuate the brake device 8 to control braking force applied to the wheels 2 and 3 in response to reception of the command signal. The steering actuator is adapted to activate the assist motor of the steering device to control a steering torque in response to reception of the command signal.

The controller 9 includes a position recognizer, an external condition recognizer, a running condition recognizer, a travel plan creator, and a travel controller.

Specifically, the position recognizer is configured to recognize a current position of the vehicle Ve on the map based on the positional information received by the GPS receiver and the map database. The current position of the vehicle Ve may also be obtained from the positional information used in the navigation system. Optionally, the vehicle Ve may also be adapted to communicate with external sensors arranged along the road to obtain the current position of the vehicle Ve.

The external condition recognizer is configured to recognize external condition of the vehicle Ve such as a location of a traffic lane, a road width, a road configuration, a road gradient, an existence of obstacles around the vehicle Ve and so on, based on the recorded information of the on-board camera, or detection data of the RADAR or the LIDAR. Optionally, weather information, a friction coefficient of road surface etc. may be obtained according to need.

The running condition recognizer is configured to recognize running condition of the vehicle Ve such as a vehicle speed, a longitudinal acceleration, a lateral acceleration, a yaw rate and so on based on detection result of the internal sensors.

The travel plan creator is configured to create a travel locus of the vehicle Ve based on a target course determined by the navigation system, a position of the vehicle Ve recognized by the position recognizer, and an external condition recognized by the external condition recognizer. That is, the travel plan creator creates a travel locus of the vehicle Ve within the target course in such a manner that the vehicle Ve is allowed to travel safely and properly while complying traffic rules.

In addition, the travel plan creator is further configured to create a travel plan in line with the created travel locus. The travel plan creator creates a travel plan in line with the target course based on the recognized external conditions and the map database.

Specifically, the travel plan is created based on prospective data after few seconds from the present moment to determine a future condition of the vehicle Ve such as a driving force or the like required in future. Optionally, the travel plan may also be created based on prospective data after several ten seconds depending on the external conditions and the running conditions. Thus, the travel plan creator creates a future plan to change a vehicle speed, acceleration, steering torque etc. during travelling along the target course in the form of e.g., a map.

Alternatively, the travel plan creator may also create a pattern to change the vehicle speed, acceleration, steering torque etc. between predetermined points on the travel locus. Specifically, such patterns may be determined by setting target values of those parameters at each point on the travel locus taking account of a required time to reach the point at the current speed.

The travel controller is configured to operate the vehicle Ve autonomously in line with the travel plan created by the travel plan creator. To this end, specifically, the travel controller transmits command signals to the throttle actuator, the brake actuator, the steering actuator and so on in accordance with the travel plan.

For example, the operating mode of the vehicle Ve is switched automatically from the autonomous mode to the manual mode when the driver operates an accelerator pedal, a brake pedal or a steering wheel during propulsion under the autonomous mode.

Specifically, the autonomous mode can be selected from a full autonomous mode in which the vehicle is operated fully autonomously, and a partial autonomous mode in which only a predetermined operation device(s) is/are operated autonomously. In the partial autonomous mode, for example, the vehicle Ve is allowed to cruise at a constant speed by operating the accelerator and a throttle valve. In this situation, optionally, the vehicle is allowed to cruise while keeping a certain distance between the vehicle Ve and a car ahead by operating the brake autonomously. By contrast, in the partial autonomous mode, only the steering wheel is operated autonomously while operating the accelerator and the brake manually.

In order to properly switch the operating mode from the manual mode to the autonomous mode on demand, the vehicle control system according to the preferred embodiment is configured to carry out the following controls.

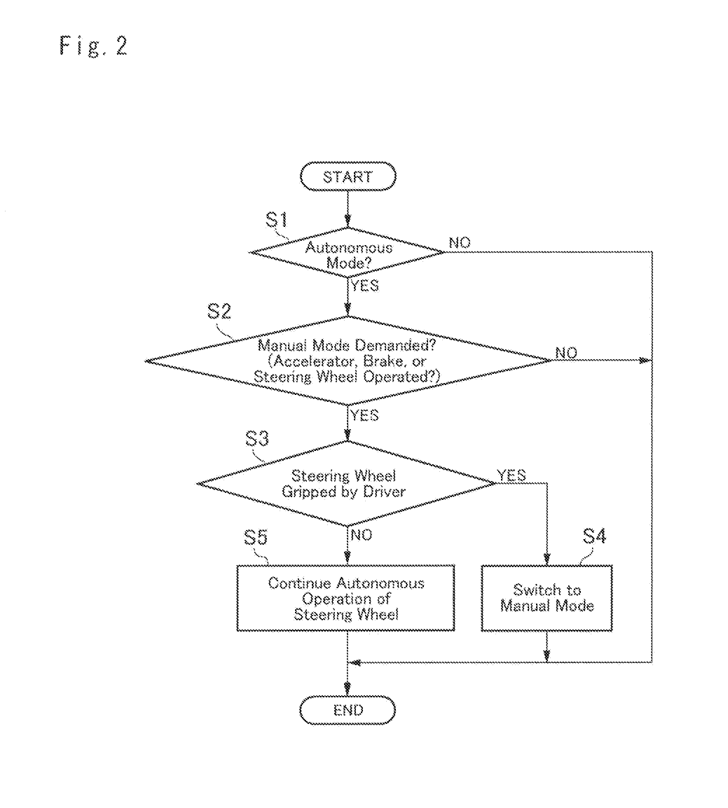

Turning to FIG. 2, there is shown a control example to be carried out when the autonomous operation is interrupted during propulsion under the autonomous mode. First of all, it is determined at step S1 whether or not the vehicle Ve is operated under the autonomous mode.

If the vehicle Ve is operated under the manual mode so that the answer of step S1 is NO, the routine is ended without carrying out any specific controls.

By contrast, if the vehicle Ve is operated under the autonomous mode so that the answer of step S1 is YES, the routine advances to step S2 to determine whether or not the manual mode is demanded. As described, the vehicle control system according to the preferred embodiment is configured to switch the operating mode automatically from the autonomous mode to the manual mode when the autonomous operation of the vehicle Ve is interrupted by an operation of the driver. At step S2, therefore, it is determined whether or not the accelerator pedal or the brake pedal is depressed by the driver, or whether or not the steering wheel is turned manually by the driver.

If the manual mode is not demanded so that the answer of step S2 is NO, the routine is ended without carrying out any specific controls.

By contrast, if the manual mode is demanded during propulsion under the autonomous mode so that the answer of step S2 is YES, the routine advances to step S3 to determine whether or not the driver grips the steering wheel to operate the steering wheel. Such determination at step S2 may be made on the basis of the detection result of steering force sensor or the steering touch sensor. At step S2, specifically, the controller 8 determines a fact that the manual mode is demanded if the steering touch sensor transits the ON signal, if the steering wheel sensor detects a torque applied to the steering wheel that is greater than a predetermined value, or the steering touch sensor transits the ON signal while the steering wheel sensor detects the torque greater than the predetermined value.

If the driver grips the steering wheel to operate the steering wheel so that the answer of step S3 is YES, the routine advances to step S4 to switch the operating mode from the autonomous mode to the manual mode. As described, the autonomous mode may be selected from the full autonomous mode and the partial autonomous mode. In other words, the manual mode may be selected from a full manual mode in which the vehicle is operated fully manually, and a partial manual mode in which the predetermined operation device(s) is/are operated autonomously. At step S4, specifically, the operating mode is switched to the full manual mode, and then the routine is ended.

By contrast, if the driver does not grip the steering wheel so that the answer of step S3 is NO, the routine advances to step S5 to switch the operating mode to the partial manual mode in which only the steering wheel is operated autonomously. That is, only the autonomous operation of the steering wheel is continued, and then the routine is ended.

Thus, if the driver does not grip the steering wheel when the operating mode is switched from the autonomous mode to the manual mode, the operating mode is switched to the partial manual mode at step S5 to continuously operate the steering wheel autonomously while allowing the driver to operate the remaining operating devices such as the accelerator pedal and the brake pedal manually. According to the preferred embodiment, therefore, the steering wheel can be maneuvered autonomously even if the steering wheel has to be operated during or after switching the operating mode from the autonomous mode to the manual mode. For this reason, the vehicle behavior can be stabilized to continuously propel the vehicle Ve in a stable manner.

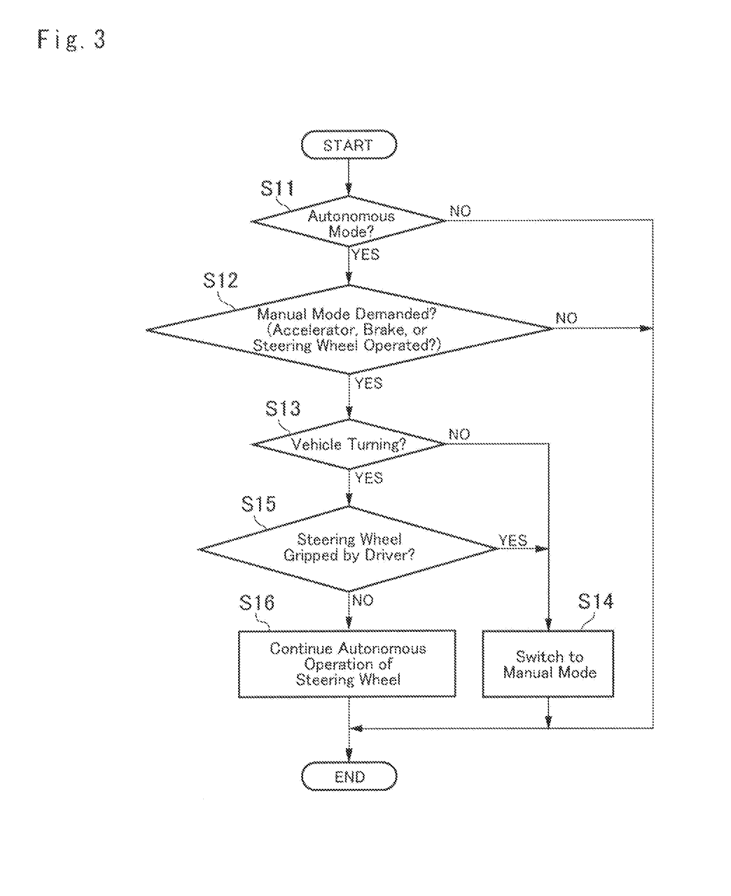

Turning to FIG. 3, there is shown another control example to be carried out when the manual mode is demanded while the vehicle Ve is making a turn. First of all, it is determined at step S11 whether or not the vehicle Ve is operated under the autonomous mode.

If the vehicle Ve is operated under the manual mode so that the answer of step S11 is NO, the routine is ended without carrying out any specific controls.

By contrast, if the vehicle Ve is operated under the autonomous mode so that the answer of step S11 is YES, the routine advances to step S12 to determine whether or not the manual mode is demanded.

If the manual mode is not demanded so that the answer of step S12 is NO, the routine is ended without carrying out any specific controls.

By contrast, if the autonomous operation of the vehicle Ve is interrupted by the above-mentioned operation(s) of the driver and hence the manual mode is demanded, the routine advances from step S12 to step S13 to determine whether or not the vehicle Ve is making a turn. At step S13, specifically, the controller 8 determines a fact that the vehicle is turning if the vehicle is propelled at a speed higher than a predetermined speed while rotating the steering wheel at a degree larger than a predetermined degree. Alternatively, it is also possible to determine that the vehicle is turning based on a fact that a speed difference between the right wheel and the left wheel is greater than a predetermined value.

If the vehicle Ve is not making a turn so that the answer of step S13 is NO, the routine advances to step S14 to switch the operating mode from the autonomous mode to the manual mode. In this case, the operating mode is switched to the full manual mode in which the autonomous operations of all of the operating devices are cancelled, and then the routine is ended.

By contrast, if the vehicle Ve is making a turn so that the answer of step S13 is YES, the routine advances to step S15 to determine whether or not to determine whether or not the driver grips the steering wheel to operate the steering wheel.

If the driver grips the steering wheel to operate the steering wheel so that the answer of step S15 is YES, the routine advances to step S14 to switch the operating mode to the full manual mode while fully cancelling the autonomous operation, and then the routine is ended.

By contrast, if the driver does not grip the steering wheel so that the answer of step S15 is NO, the routine advances to step S16 to switch the operating mode to the partial manual mode in which only the steering wheel is operated autonomously. That is, only the autonomous operation of the steering wheel is continued, and then the routine is ended.

Thus, if the driver does not grip the steering wheel when the operating mode is switched from the autonomous mode to the manual mode during turning, the operating mode is switched to the partial manual mode at step S15 to continuously operate the steering wheel autonomously while allowing the driver to operate the remaining operating devices such as the accelerator pedal and the brake pedal manually. According to the preferred embodiment, therefore, the steering wheel can be maneuvered autonomously even if the steering wheel has to be operated during or after switching the operating mode from the autonomous mode to the manual mode. For this reason, the vehicle behavior can be stabilized to continuously propel the vehicle Ve in a stable manner.

Although the above exemplary embodiments of the present application have been described, it will be understood by those skilled in the art that the present application should not be limited to the described exemplary embodiments, and various changes and modifications can be made within the spirit and scope of the present application. For example, a layout of the vehicle to which the control system according to the preferred embodiment is applied may be altered arbitrarily according to need.

What is claimed is:

1. A vehicle control system that is configured to select an operating mode of a vehicle from an autonomous mode in which the vehicle is operated autonomously and a manual mode in which the vehicle is operated manually by a driver, and to switch the operating mode from the autonomous mode to the manual mode when an autonomous control of the vehicle is interrupted by a manual operation of a driver, comprising a controller that is configured to:
control an operating condition of the vehicle;
determine an execution of steering operation by the driver; and
continue the autonomous control of the steering wheel if the steering wheel cannot be operated by the driver when the autonomous control of the vehicle is interrupted by a manual operation of a driver and hence the operating mode is switched from the autonomous mode to the manual mode.

2. The vehicle control system as claimed in claim 1, wherein the controller is further configured to:
continue the autonomous control of the steering wheel if the steering wheel cannot be operated by the driver when the autonomous control of the vehicle is interrupted by a manual operation of a driver while the vehicle is making a turn and hence the operating mode is switched from the autonomous mode to the manual mode.
